(19) United States
(12) Patent Application Publication
(10) Pub. No.: US 2026/0109331 A1
(43) Pub. Date: Apr. 23, 2026

(54) SYSTEM AND METHOD FOR CONTROLLING PARKING BRAKE USING BACK ELECTROMOTIVE FORCE

(71) Applicant: HL MANDO CORPORATION, Gyeonggi-do (KR)

(72) Inventor: Aniket KUMAR, Bay City, MI (US)

(21) Appl. No.: 18/923,684

(22) Filed: Oct. 23, 2024

(51) Int. Cl. B60T 8/172; B60T 8/171; B60T 13/74; F16D 65/18; F16D 121/24; H02P 3/04

(52) U.S. Cl. CPC B60T 8/172; B60T 8/171; B60T 13/746; F16D 65/18; H02P 3/04; F16D 2121/24

(57) ABSTRACT

An electromechanical brake system may comprise: an electric motor mechanically connected to a brake pad assembly to apply a parking brake; and a controller electrically connected to the electric motor. The controller is configured to, in response to a voltage associated with a back electromotive force generated by rotation of the electric motor caused by movement of the brake pad assembly, check a status of the parking brake and/or control the electric motor to re-apply the parking brake. A force of the parking brake re-applied in response to the voltage associated with the back electromotive force generated by the electric motor may be larger than a force of the parking brake previously applied before re-applying the parking brake.

### BACKGROUND

Various embodiments of the present disclosure generally relate to an electromechanical brake system and more particularly to a system and method for controlling a parking brake using a voltage associated with a back electromotive force generated by rotation of an electric actuator caused by movement of a brake pad.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” and electric or “brake by wire.” For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

Generally, the brake system may include a service brake assembly and a parking brake assembly. The parking brake assembly may be used to prevent movement of the vehicle when a vehicle is stopped or parked. The parking brake assembly may be a discrete assembly, or may utilize one or more components of the service brake assembly. That is, the parking brake assembly may use the piston and the brake pads of the service brake assembly to create the brake apply. For example, the parking brake assembly may move the piston, which may move the brake pads into contact with the rotor to create and maintain a brake apply by clamping force applied to the rotor.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake system may comprise: an electric motor mechanically connected to a brake pad assembly to apply a parking brake; and a controller electrically connected to the electric motor and configured to control the electric motor to re-apply the parking brake in response to a voltage associated with a back electromotive force generated by rotation of the electric motor caused by movement of the brake pad assembly.

The controller may be configured to control the electric motor such that a force of the parking brake re-applied in response to the voltage associated with the back electromotive force generated by the electric motor is larger than a force of the parking brake previously applied before re-applying the parking brake.

The electromechanical brake system may further comprise a circuit connected between the electric motor and the controller and configured to rectify a voltage generated by the electric motor into a direct current (DC) voltage and compare the rectified DC voltage with a preset voltage to output the voltage associated with the back electromotive force generated by the rotation of the electric motor caused by the movement of the brake pad assembly.

The preset voltage to be compared with the rectified DC voltage to output the voltage associated with the back electromotive force may be set to be zero (0).

The circuit may be electrically connected to at least one of multi-phase windings of the electrical motor.

The controller may be configured to, when the controller is in an inactive state, be waked up by the voltage associated with the back electromotive force generated by the rotation of the electric motor caused by the movement of the brake pad assembly.

The controller may be configured to, in response to the voltage associated with the back electromotive force generated by the rotation of the electric motor caused by the movement of the brake pad assembly, check a status of the parking brake and control the parking brake depending on the status of the parking brake.

According to certain embodiments of the present disclosure, an electromechanical brake system may comprise: an electric motor mechanically connected to a brake pad assembly to apply a parking brake; and a controller electrically connected to the electric motor and configured to, in response to a voltage associated with a back electromotive force generated by rotation of the electric motor caused by movement of the brake pad assembly, check a status of the parking brake and control the parking brake depending on the status of the parking brake.

The controller may be configured to, when the controller is in an inactive state, be waked up by the voltage associated with the back electromotive force generated by the rotation of the electric motor caused by the movement of the brake pad assembly.

The controller may be configured to re-apply the parking brake in response to the voltage associated with the back electromotive force generated by the rotation of the electric motor caused by the movement of the brake pad assembly.

The controller may be configured to control the electric motor such that a force of the parking brake re-applied in response to the voltage associated with the back electromotive force generated by the electric motor is larger than a force of the parking brake previously applied before re-applying the parking brake.

The electromechanical brake system may further comprise a circuit connected between the electric motor and the controller and configured to rectify a voltage generated by the electric motor into a direct current (DC) voltage and compare the rectified DC voltage with a preset voltage to output the voltage associated with the back electromotive force generated by the rotation of the electric motor caused by the movement of the brake pad assembly.

The preset voltage to be compared with the rectified DC voltage to output the voltage associated with the back electromotive force may be set to be zero (0).

The circuit may be electrically connected to at least one of multi-phase windings of the electrical motor.

According to some embodiments of the present disclosure, a method of controlling a parking brake of an electromechanical brake system may comprise: applying a parking brake by actuating an electric motor mechanically connected to a brake pad assembly; and by a controller, in response to a voltage associated with a back electromotive force generated by rotation of the electric motor caused by movement of the brake pad assembly, controlling the electric motor to re-apply the parking brake.

A force of the parking brake re-applied in response to the voltage associated with the back electromotive force generated by the electric motor may be larger than a force of the parking brake generated by the applying of the parking brake.

The method may further comprise: rectifying a voltage generated by the electric motor into a direct current (DC) voltage; and comparing the rectified DC voltage with a preset voltage to output the voltage associated with the back electromotive force generated by the rotation of the electric motor caused by the movement of the brake pad assembly.

The preset voltage to be compared with the rectified DC voltage to output the voltage associated with the back electromotive force may be set to be zero (0).

When the controller is in an inactive state, the controller may be waked up by the voltage associated with the back electromotive force generated by the rotation of the electric motor caused by the movement of the brake pad assembly.

The method may further comprise, in response to the voltage associated with the back electromotive force generated by the rotation of the electric motor caused by the movement of the brake pad assembly, checking a status of the parking brake and control the parking brake depending on the status of the parking brake.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 is a cross-sectional view of a brake assembly according to an exemplary embodiment of the present disclosure;

FIG. 2 is a block diagram for showing a system of controlling a parking brake according to an exemplary embodiment of the present disclosure;

FIG. 3 is a flow chart for illustrating a method of controlling a parking brake according to an exemplary embodiment of the present disclosure; and

FIG. 4 is a graph for illustrating operations of controlling a parking brake according to an exemplary embodiment of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

A vehicle is equipped with a parking brake to prevent movement of wheels when the vehicle is not in operation, for instance, when the vehicle is stopped or parked. The parking brake may refer to a mechanism for restraining or holding a parked vehicle in place. The parked status of the vehicle can be maintained by a parking lock mechanism, for example, but not limited to, a strut, a parking pawl, engagement of one or more gears, and so on. A reliable parking brake operation is particularly important for safety. However, when the vehicle is not in operation, as when the parking brake is needed, the parking brake may be accidentally disengaged or released. For instance, the parking brake may not provide a force sufficient to clamp brake pads to prevent rolling of the vehicle, or the parking lock mechanism may not be appropriately engaged. A brake control system for controlling the parking brake needs to be designed to assure that the parking brake remains securely engaged.

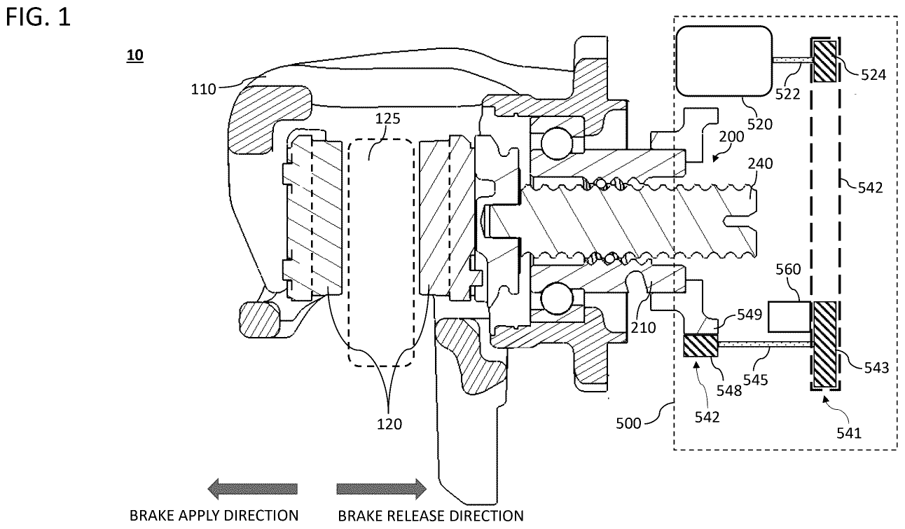

According to some embodiments of the present disclosure, the status of the parking brake such as park brake loss or insufficient park brake force may be detected or determined based on a back electromotive force (back-EMF) of an electric motor. In order to detect or determine the status of the parking brake using the back-EMF of the electric motor, the electric motor may require to be mechanically connected to a brake pad assembly configured to clamp a rotor of a wheel. For instance, an electro-mechanical brake (EMB) and an electronic parking brake (EPB) may comprise a mechanical connection between the electric motor and the brake pad assembly so that the electric motor actuated by electrical energy can mechanically move the brake pad assembly toward or away from the rotor of the wheel to apply or release the parking brake. One example of the mechanical connection between the electric motor and the brake pad assembly is illustrated in FIG. 1.

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. Brake pad assemblies (or brake lining assemblies) 120 are provided in the brake caliper 110. The brake caliper 110 may include a bridge with fingers, and the fingers of the brake caliper 110 may be in contact with the brake pad assemblies 120. The brake assembly 120 is disposed with a small air clearance on a side of the brake rotor 125, such as a brake disc, in a release position so that no significant residual drag moment occurs.

The brake assembly 10 may comprise a screw mechanism 200 (e.g. a ball screw mechanism or a nut-screw mechanism) configured to convert rotary motion generated by an actuator assembly 500 into linear motion in order to move the brake pad assembly 120 toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500, and is configured to be rotatable by actuation of the actuator assembly 500.

The actuator assembly 500 may comprises the electric motor 520. For example, the electric motor 520 may be directly engaged with the rotatably part 210. Alternatively, the electric motor 520 is indirectly connected to the rotatably part 210 through means for transferring rotary force generated by the electric motor 520, such as one or more gears, one or more belts, one or more pulleys, any other connecting means and combination thereof.

The actuator assembly 500 may have a multi-stage drive mechanism 540, although not required. The multi-stage drive mechanism 540 may be, for example, but not limited to, a dual-stage drive mechanism comprising a belt drive mechanism 541 and a gear drive mechanism 542 to multiply torque from the electric motor 520 to supply rotary force to the rotatable body 210 of the drive mechanism 200. The belt drive mechanism 541 multiplies the torque from the electric motor 520 by using a drive pully 524 and a driven pulley 543 rotatably connected by a drive belt 542, and the torque multiplied by the belt drive mechanism 541 is delivered to the gear drive mechanism 546 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 546. The first gear 548 is rotatably engaged with the second gear 549 to rotate the second gear 549 by the rotary torque transmitted through the intermediate shaft 545. The second gear 549 may be formed directly on a part of the circumferential surface of the rotatable body or nut 210 of the drive mechanism or screw-nut mechanism 200, or be mounted to the rotatable body 210 of the drive mechanism 200 to rotate the rotatable body or nut 210.

The mechanical connection between the electric motor 520 and the brake pad assemblies 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assemblies 120 can be used.

Because the electric motor 520 and the brake pad assembly 120 are mechanically connected to each other, the movement of the brake pad assembly 120 can cause the electric motor 500 to move. For instance, if the brake pad assembly 120 moves, a rotor of the electric motor 520 (e.g. the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g. the motor shaft 522) to rotate due to the mechanical connection between the electric motor 520 and the brake pad assemblies 120.

In a state that electric power is not supplied to the electric motor 520 (e.g., when the operation of applying the parking brake is completed or when the ignition or power of the vehicle is turned off), if the rotor of the electric motor 520 is rotated by the movement of the brake pad assembly 120, the rotation of the rotor of the electric motor 520 can produce back-EMF voltages in multi-phase windings of the electric motor 520.

A circuit 600 (e.g. a voltage sensor or detector) is electrically connected to the electric motor 520 and is configured to detect a voltage of the back-EMF generated by the rotation of the electric motor 520 caused by movement of the brake pad assembly 120 after the operation of applying the parking brake is completed and/or when a controller 700 configured to control the brake assembly 10 is in an inactive state.

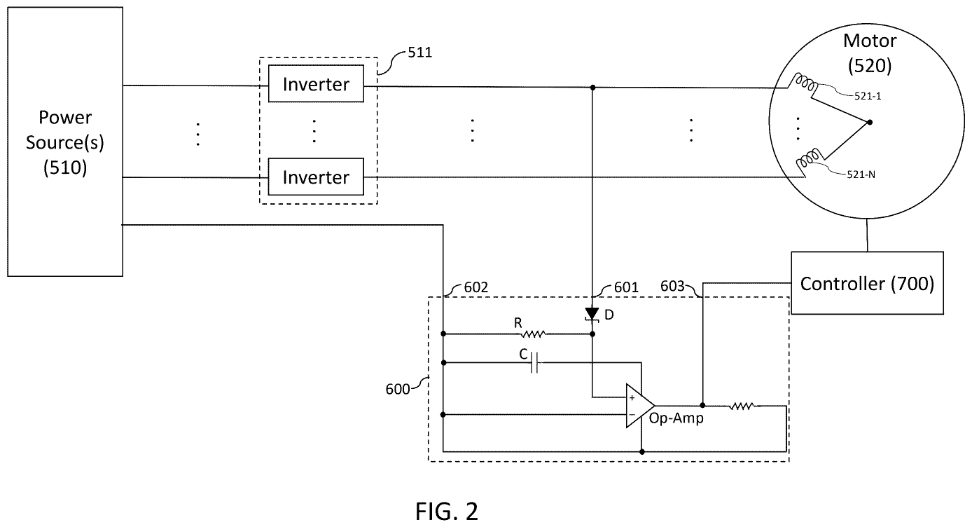

An exemplary embodiment of the circuit 600 is illustrated in FIG. 2. The voltage sensor or detector 600 is electrically connected to at least one of multi-phase windings 521-1 to 521-N. For instance, a first terminal 601 of the voltage sensor or detector 600 is connected to one of the multi-phase windings 521-1 to 521-N and a second terminal 602 of the voltage sensor or detector 600 is grounded or connected to one terminal of a power source 510 configured to supply power through one or more inverters 511 to the electric motor 520. The circuit 600 may be configured to rectify one of multi-phase voltages of the electric motor 500 into a direct current (DC) voltage, and compare the rectified DC voltage of the electric motor 500 with a preset voltage. In FIG. 2, the combination of a resistor R, a capacitor C, and a diode D can rectify one phase voltage of the electric motor 500, and an operational amplifier Op-Amp can output a signal representing comparison between the rectified DC voltage of the electric motor 500 and the preset voltage. The preset voltage may be zero (0), but not limited thereto. If the back-EMF voltage generated by the electric motor 520 is detected by the voltage sensor or detector 600, the voltage sensor or detector 600 may output a positive voltage to a controller 700.

The controller 700 may be configured to control the electric motor 520 to perform the operation of the parking brake such as a parking brake application or a parking brake release. For instance, the controller 700 may control the electric motor 520 by controlling the inverters 511 connected between the power source 510 and the electric motor 520. The controller 700 may be, for example, but not limited to, a micro-controller unit (MCU), a circuit chip, a semiconductor circuit, and a circuit board having memory, one or more processors, and electric components.

For instance, a third terminal 603 of the circuit 600, connected to an output terminal of the operational amplifier Op-Amp, may be connected to a wakeup terminal or pin WUP of the controller 700. Accordingly, the positive voltage output from the voltage sensor or detector 600, caused by the back-EMF of the electric motor 520, may be supplied to the controller 700. When the controller 700 is in an inactive state, the positive voltage output from the voltage sensor or detector 600, caused by the back-EMF of the electric motor 500, can wake up the controller 700 so that the controller 700 can control the brake assembly 10 including the electric motor 520. However, if the controller 700 is in an active state when receiving the positive voltage from the voltage sensor or detector 600, the controller 700 does not need to perform a wake-up operation in response to the positive voltage received from the voltage sensor 600.

When the controller 700 is supplied with the voltage caused by the back-EMF of the electric motor 500 from the voltage sensor or detector 600, the controller 700 may check the status of the parking brake. If the controller 700 detects the failure, fault, or abnormality of the parking brake based on the status of the parking brake, the controller 700 controls the electric motor 500 to re-apply a parking brake to provide sufficient clamping force against the rotor 125 of the wheel. For example, a force of the parking brake re-applied in response to the detection of the back-EMF from the electric motor 520 may be larger than a force of the parking brake previously applied before re-applying the parking brake.

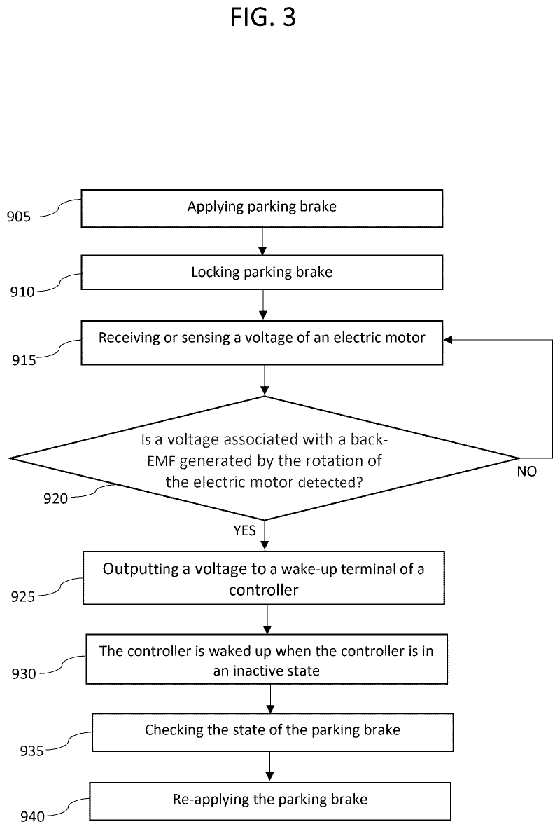

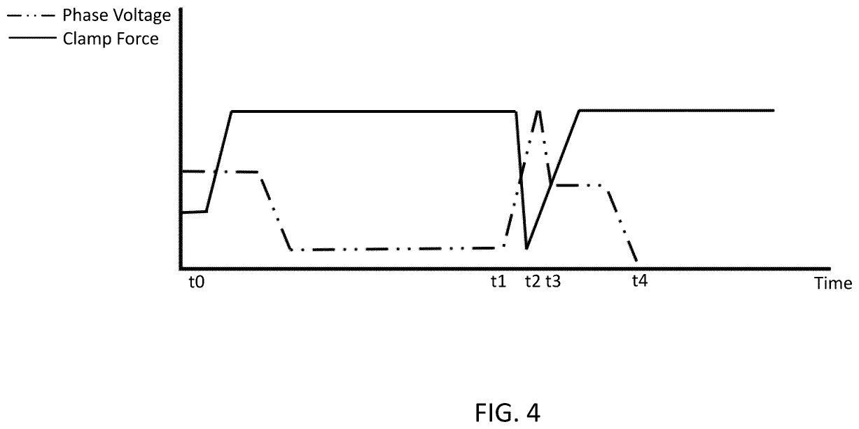

FIG. 3 is a flowchart for illustrating a method of controlling a park brake according to an embodiment of the present disclosure. FIG. 4 is a graph for illustrating operations of controlling a parking brake according to an exemplary embodiment of the present disclosure.

At step 905, the controller 700 controls the inverter 511 to supply power from the power source 510 to the electronic motor 520 to apply parking brake by rotating the electronic motor 520 and then moving the brake assembly 120. The electronic motor 520 is activated, causing the brake pad assembly 120 to move toward the rotor 125 of the wheel in order to apply a brake clamping force that prevents the movement of the vehicle.

If the parking brake is properly engaged by applying sufficient brake clamping force to the rotor 125 of the wheel, the motor torque generated by the electric motor 520 is decreased to allow a parking lock mechanism 560 to prevent moving the brake pad assembly 120 in the release direction. For instance, a strut, a parking pawl or a gear included in the parking lock mechanism 560 may be engaged with any component of the drive mechanism 200 or the actuator assembly 500, such as notches formed on a gear in order to lock the movement of the brake assembly 120. The details of exemplary embodiments of the parking lock mechanism 560 are described in U.S. application No. Ser. No. 17/579,552, filed on Jan. 19, 2022 and published as U.S. Patent Application Publication No. 2023/0228309 on Jul. 20, 2023, the entire teachings of which are incorporated by reference herein.

At step 910, after the parking lock mechanism 560 is interlocked with any component of the drive mechanism 200 or the actuator assembly 500 so that the brake pad assembly 120 is incapable of moving in the brake release direction, the torque generated by the electric motor 520 is released and the parking brake state can be maintained by the parking lock mechanism 560. Therefore, the brake clamp force can be maintained without reduction of the brake clamp force in the power off condition.

However, the parking brake locked by the parking lock mechanism 560 may be accidentally disengaged or released. For instance, the parking brake may not provide a force sufficient to clamp brake pads to prevent rolling of the vehicle, or the parking lock mechanism 560 such as a strut, a parking pawl or a gear may not be appropriately engaged.

Therefore, after the parking brake is locked by the parking lock mechanism 560 at step 910, the voltage sensor or detector 600 electrically connected to the electric motor 520 receives or senses a voltage of one of the multi-phase windings 521-1 to 521-N of the electric motor 520 (step 915).

At step 920, the voltage sensor or detector 600 may detect a voltage associated with the back-EMF generated by the rotation of the electric motor 520 caused by the movement of the brake pad assembly 120. In a state that the electric power is not supplied to the electric motor 520 from the power source 510 (e.g., when the operation of applying the parking brake is completed or when the ignition or power of the vehicle is turned off), if the rotor of the electric motor 520 is rotated by the movement of the brake pad assembly 120 through the mechanical connection between the brake pad assembly 120 and the electric motor 520, the rotation of the rotor of the electric motor 520 can produce back-EMF voltages in multi-phase windings of the electric motor 520.

For instance, referring to FIG. 4, after time period from t₀ to t₁ in which a normal parking brake operation is performed at steps 905 and 910, one of multi-phase voltages of the electric motor 500 increases due to the back-EMF generated by the rotation of the electric motor 520 caused by accidental release of the brake pad assembly 120 and the clamp force of the parking brake decreases during a time period from t₁ to t₂.

In an exemplary embodiment of the present disclosure, at step 920, the voltage sensor or detector 600 rectifies one of multi-phase voltages of the electric motor 500, received at step 915, into a direct current (DC) voltage, and compares the rectified DC voltage of the electric motor 500 with a preset voltage. For instance, the preset voltage may be zero (0), but not limited thereto.

If the back-EMF voltage generated by the electric motor 520 is detected by the voltage sensor or detector 600 at step 920, the voltage sensor or detector 600 outputs a positive voltage to the controller 700 (step 925). Accordingly, the positive voltage output from voltage sensor or detector 600, caused by the back-EMF of the electric motor 520, may be supplied to the controller 700. For example, the positive voltage caused by the back-EMF of the electric motor 520 may be output to a wakeup terminal or pin WUP of the controller 700.

At step 930, when the controller 700 is in an inactive state, the positive voltage output from the voltage sensor or detector 600, caused by the back-EMF of the electric motor 500, wakes up the controller 700 so that the controller 700 can control the brake assembly including the electric motor 520. However, if the controller 700 is in an active state when receiving the positive voltage from the voltage sensor or detector 600, the controller 700 does not need to perform a wakeup operation in response to the positive voltage received from the voltage sensor or detector 600.

At step 935, the controller 700 may check the status of the parking brake.

At step 940, in response to the voltage caused by the back-EMF of the electric motor 500 from the voltage sensor 600, if the controller 700 detects the failure, fault, or abnormality of the parking brake based on the status of the parking brake, the controller 700 controls the electric motor 500 to re-apply a parking brake to provide sufficient clamping force against the rotor 125 of the wheel. For example, at step 940, a force of the parking brake re-applied in response to the detection of the back-EMF from the electric motor 520 may be larger than a force of the parking brake previously applied at step 905.

For example, referring to FIG. 4, during the spike of the voltage of one of multi-phase voltages of the electric motor 500 at time period from t₁ to t₂, the controller 700 is waked up by the voltage caused by the back-EMF of the electric motor 500, and then controls to re-apply the parking brake during time period from t₁ to t₂ and/or time period from t₂ to t₃. During time period from t₂ to t₃, the re-application of the parking brake is completed, and during time period from t₃ to t₄, the controller 700 is reset and becomes in an inactive state. And, a force of the parking brake re-applied at time period from t₁ to t₂ and/or time period from t₂ to t₃ may be larger than a force of the parking brake previously applied at time period from t₀ to t₁.

Accordingly, when a parking brake is accidently released or fails to maintain enough brake clamping force, some embodiments of the present disclosure may re-apply the parking brake in response to a voltage associated with a back electromotive force generated by rotation of an electric motor caused by movement of a brake pad. According to certain embodiments of the present disclosure, no controller may need to keep alive to monitor accidental release of the parking brake and a controller controlling the parking brake can be waked up by using a voltage generated by a back electromotive force generated by rotation of the electric motor caused by the movement of the brake pad due to the accidental release of the parking brake.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake system comprising:
an electric motor mechanically connected to a brake pad assembly to apply a parking brake; and
a controller electrically connected to the electric motor and configured to control the electric motor to re-apply the parking brake in response to a voltage associated with a back electromotive force generated by rotation of the electric motor caused by movement of the brake pad assembly.

2. The electromechanical brake system of claim 1, wherein the controller is configured to control the electric motor such that a force of the parking brake re-applied in response to the voltage associated with the back electromotive force generated by the electric motor is larger than a force of the parking brake previously applied before re-applying the parking brake.

3. The electromechanical brake system of claim 1, further comprising a circuit connected between the electric motor and the controller and configured to rectify a voltage generated by the electric motor into a direct current (DC) voltage and compare the rectified DC voltage with a preset voltage to output the voltage associated with the back electromotive force generated by the rotation of the electric motor caused by the movement of the brake pad assembly.

4. The electromechanical brake system of claim 3, wherein the preset voltage to be compared with the rectified DC voltage to output the voltage associated with the back electromotive force is set to be zero (0).

5. The electromechanical brake system of claim 3, wherein the circuit is electrically connected to at least one of multi-phase windings of the electrical motor.

6. The electromechanical brake system of claim 1, wherein the controller is configured to, when the controller is in an inactive state, be waked up by the voltage associated with the back electromotive force generated by the rotation of the electric motor caused by the movement of the brake pad assembly.

7. The electromechanical brake system of claim 1, wherein the controller is configured to, in response to the voltage associated with the back electromotive force generated by the rotation of the electric motor caused by the movement of the brake pad assembly, check a status of the parking brake and control the parking brake depending on the status of the parking brake.

8. An electromechanical brake system comprising:
an electric motor mechanically connected to a brake pad assembly to apply a parking brake; and
a controller electrically connected to the electric motor and configured to, in response to a voltage associated with a back electromotive force generated by rotation of the electric motor caused by movement of the brake pad assembly, check a status of the parking brake and control the parking brake depending on the status of the parking brake.

9. The electromechanical brake system of claim 8, wherein the controller is configured to, when the controller is in an inactive state, be waked up by the voltage associated with the back electromotive force generated by the rotation of the electric motor caused by the movement of the brake pad assembly.

10. The electromechanical brake system of claim 8, wherein the controller is configured to re-apply the parking brake in response to the voltage associated with the back electromotive force generated by the rotation of the electric motor caused by the movement of the brake pad assembly.

11. The electromechanical brake system of claim 10, wherein the controller is configured to control the electric motor such that a force of the parking brake re-applied in response to the voltage associated with the back electromotive force generated by the electric motor is larger than a force of the parking brake previously applied before re-applying the parking brake.

12. The electromechanical brake system of claim 8, further comprising a circuit connected between the electric motor and the controller and configured to rectify a voltage generated by the electric motor into a direct current (DC) voltage and compare the rectified DC voltage with a preset voltage to output the voltage associated with the back electromotive force generated by the rotation of the electric motor caused by the movement of the brake pad assembly.

13. The electromechanical brake system of claim 12, wherein the preset voltage to be compared with the rectified DC voltage to output the voltage associated with the back electromotive force is set to be zero (0).

14. The electromechanical brake system of claim 12, wherein the circuit is electrically connected to at least one of multi-phase windings of the electrical motor.

15. A method of controlling a parking brake of an electromechanical brake system, the method comprising:
applying a parking brake by actuating an electric motor mechanically connected to a brake pad assembly; and
by a controller, in response to a voltage associated with a back electromotive force generated by rotation of the electric motor caused by movement of the brake pad assembly, controlling the electric motor to re-apply the parking brake.

16. The method of claim 15, wherein a force of the parking brake re-applied in response to the voltage associated with the back electromotive force generated by the electric motor is larger than a force of the parking brake generated by the applying of the parking brake.

17. The method of claim 15, further comprising:
rectifying a voltage generated by the electric motor into a direct current (DC) voltage; and
comparing the rectified DC voltage with a preset voltage to output the voltage associated with the back electromotive force generated by the rotation of the electric motor caused by the movement of the brake pad assembly.

18. The method of claim 17, wherein the preset voltage to be compared with the rectified DC voltage to output the voltage associated with the back electromotive force is set to be zero (0).

19. The method of claim 15, wherein, when the controller is in an inactive state, the controller is waked up by the voltage associated with the back electromotive force generated by the rotation of the electric motor caused by the movement of the brake pad assembly.

20. The method of claim 15, further comprising, in response to the voltage associated with the back electromotive force generated by the rotation of the electric motor caused by the movement of the brake pad assembly, checking a status of the parking brake and control the parking brake depending on the status of the parking brake.
